(19) United States
(12) Patent Application Publication
(10) Pub. No.: US 2016/0117634 A1
(43) Pub. Date: Apr. 28, 2016

(54) Real-Time Equipment Inventory Collection in an Enterprise Server Environment

(71) Applicant: Dell Products L.P., Round Rock, TX (US)

(72) Inventors: Dinesh Kunnathur Ragupathi, Round Rock, TX (US); Akkiah Choudary Maddukuri, Austin, TX (US)

(73) Assignee: DELL PRODUCTS L.P., Round Rock, TX (US)

(21) Appl. No.: 14/525,900

(22) Filed: Oct. 28, 2014

(51) Int. Cl. G06Q 10/08; H04L 29/08

(52) U.S. Cl. CPC G06Q 10/087; H04L 67/10

(57) ABSTRACT

A system, method, and computer-readable medium are disclosed for enabling a user to identify excess equipment inventory within a particular information handling system located within an enterprise environment such as via a management controller. In certain embodiments, the management controller comprises a remote access controller such as a Dell iDRAC type management controller. In certain embodiments, the management controller provides low level control for all hardware included within the enterprise environment. Also, in certain embodiments, the management controller comprises a Lifecycle controller which maintains hardware and software inventory.

### BACKGROUND OF THE INVENTION

1. Field of the Invention

The present invention relates to information handling systems. More specifically, embodiments of the invention relate to real-time excess equipment inventory identification in an enterprise server environment.

2. Description of the Related Art

As the value and use of information continues to increase, individuals and businesses seek additional ways to process and store information, One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One issue that relates to information handling systems is when a plurality of information handling systems are intended for use within an enterprise environment. With such an environment it is desirable to be able to determine whether equipment (including information handling systems as well as components contained within or associated with information handling systems) are not needed within the environment. Even though server type information handling systems may be configured and built according to customer input, the systems may be configured with (or at some time after install be changed to have) excess equipment. For example, a customer may configure a server type information handling system in which an out of band shared storage system (such as vFlash) is disabled. However, the system may still be configured with a secure digital (SD) card even if the VFlash is disabled. As another example, a customer may configure a server type information handling system to not include or connect a power cable to a power supply unit. In such a configuration, the power supply unit may be excess equipment.

### SUMMARY OF THE INVENTION

A system, method, and computer-readable medium are disclosed for enabling a user to identify excess equipment inventory within a particular information handling system located within an enterprise environment such as via a management controller. In certain embodiments, the management controller comprises a remote access controller such as a Dell iDRAC type management controller. In certain embodiments, the management controller provides low level control for all hardware included within the enterprise environment and includes configuration functionality using Complex programmable logic device(CPLD), Basic Input/Output System (BIOS), Intel Node Manager(NM), Power Management Bus (PMBUS), Inter-Integrated Circuit(i2c), side band interfaces ((HII), Comprehensive Embedded Management (CEM), Network Controller Sideband Interface (NCSI)), Thermal table, power budget table and etc. Also, in certain embodiments, the management controller comprises a Lifecycle controller which maintains hardware and software inventory.

Also, in certain embodiments, the excess equipment inventory identification uses key configuration factors such as cable detection, link status, etc. to determine whether certain equipment is in use. Also in certain embodiments, the excess equipment inventory identification uses configuration data to determine whether certain equipment is enabled or disabled. Also, in certain embodiments, the excess equipment inventory identification tracks usage of a specific component to associate additional usage information with any identified excess equipment. Also, in certain embodiments, the excess equipment inventory identification is performed when components are added to the enterprise environment. Also, in certain embodiments, the excess equipment inventory identification provides usage recommendations regarding whether and where any identified excess equipment may be used within the enterprise environment. Also, in certain embodiments, the excess equipment inventory identification aggregates all identified excess equipment and provides a master excess equipment inventory report at a console level. Also, in certain embodiments, the excess equipment inventory identification also identifies under-utilized components within the enterprise environment such as by tracking usage of components within the enterprise environment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of an example enterprise environment in which the excess equipment inventory system operations.

FIG. 3 shows a block diagram of an excess equipment inventory system.

FIG. 4 shows an example of a server type information handling system on which the excess equipment inventory system performs an analysis.

FIG. 5 shows a flow chart of the operation of an excess equipment inventory system when performing an analysis for excess fan equipment.

FIG. 6 shows a flow chart of the operation of an excess equipment inventory system when performing another analysis for excess fan equipment.

FIG. 7 shows a table representing the various conditions analyzed by the excess equipment inventory system when performing an analysis for excess fan equipment.

FIG. 8 shows a flow chart of the operation of an excess equipment inventory system when performing an analysis for excess equipment inventory when a new device is added to the enterprise environment.

FIG. 9 shows an example screen presentation of an excess equipment inventory report generated by an excess equipment inventory system.

### DETAILED DESCRIPTION

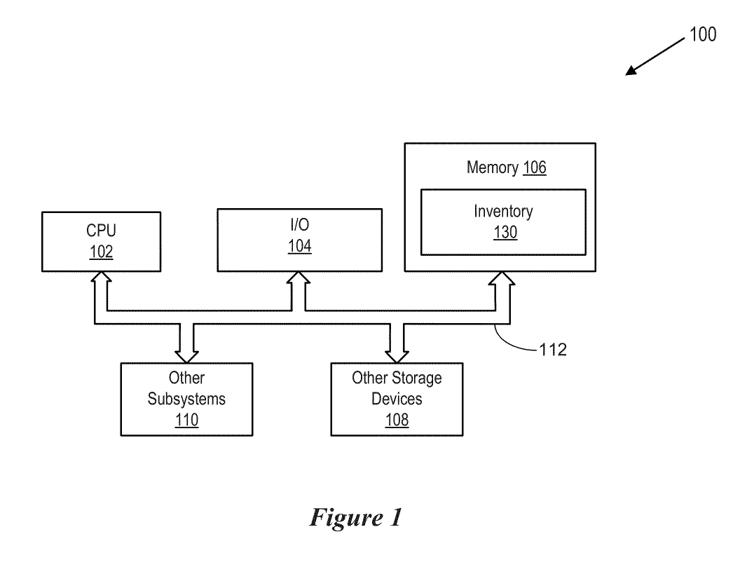

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, memory 106, and various other subsystems 108. The information handling system 100 likewise includes other storage devices 110. The components of the information handling system are interconnected via one or more buses 112.

In certain embodiments, such as when the information handling system corresponds to a host or server type information handling system, the memory 106 stores an excess equipment inventory identification system 130 which includes instructions executable by the processor 102. The excess equipment inventory identification system 130 enables a user to dynamically and in real-time identify excess equipment inventory within a particular information handling system located within an enterprise environment such as via a management controller. In certain embodiments, the management controller comprises an integrated Dell Remote Access Controller (iDRAC) type management controller. In certain embodiments, the management controller provides low level control for all hardware included within the enterprise environment and includes configuration functionality using power supply logic, BIOS, NM, PMBUS, i2c, side band interfaces, thermal table, power budget table and etc. Also, in certain embodiments, the management controller comprises a Lifecycle controller which maintains hardware and software inventory.

Also, in certain embodiments, the excess equipment inventory identification uses key configuration factors such as cable detection, link status, etc. to determine whether certain equipment is in use. Also in certain embodiments, the excess equipment inventory identification uses configuration data to determine whether certain equipment is enabled or disabled. Also, in certain embodiments, the excess equipment inventory identification tracks usage of a specific component to associate additional usage information with any identified excess equipment. Also, in certain embodiments, the excess equipment inventory identification is performed when components are added to the enterprise environment. Also, in certain embodiments, the excess equipment inventory identification provides usage recommendations regarding whether and where any identified excess equipment may be used within the enterprise environment. Also, in certain embodiments, the excess equipment inventory identification aggregates all identified excess equipment and provides a master excess equipment inventory report at a console level. Also, in certain embodiments, the excess equipment inventory identification also identifies under-utilized components within the enterprise environment such as by tracking usage of components within the enterprise environment.

The term excess equipment refers to hardware devices which are installed in an information handling system (such as a server type information handling system) but are not currently used or needed by the information handling system. Excess equipment may include hardware which is disabled by a certain configuration or in which external cables are not connected. For example, certain server type information handling systems may include an extra power supply (e.g., where the power supply is installed, but no power cable is connected to the power supply or no power signal is detected to the power supply, an extra fan (e.g., a fan which is installed but as an optional or redundant fan), an unused hypervisor, a unused SD card (e.g., when Vii is not configured within the information handling system), an unused network card (e.g., where a network card is installed, but no cable is attached or no network traffic is present on the port), etc.

In certain embodiments, the excess equipment inventory identification system allows identified excess equipment to be used elsewhere within the enterprise environment. For example, if a first server (e.g., Server A) has an SD card installed but VFlash feature disabled, while another server (e.g., Server B) needs an SD card then customer can use the SD card located within the first server for the other server by querying and identifying excess items. Also for example, in an enterprise environment where a resource is shared among multiple servers, a user may move the excess equipment resource from a system in which it is located to another system within the enterprise environment. The system can further provide information regarding how long the excess equipment may be moved. For example, in certain cases the excess equipment may be needed at a later time if a server is planned to be used at a higher power level in the future. The excess equipment inventory identification system can further provide information regarding the excess equipment such as in which other systems within the enterprise environment the excess equipment is supported or may be used. A power supply is an example of a resource that may be shared among multiple servers. In this case, an excess power supply may be identified as a power supply to which no cable is connected.

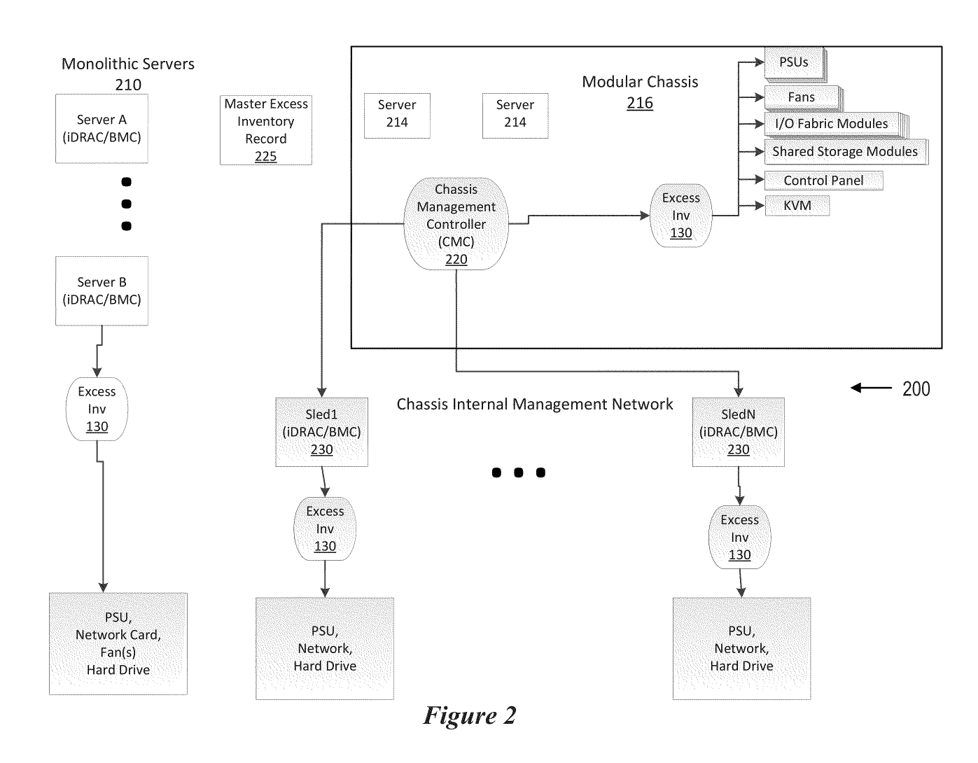

Referring to FIG. 2, a block diagram of a physical view of an example enterprise environment 200 which includes a system for performing excess equipment inventory operations is shown. More specifically, in certain embodiments the enterprise environment includes a one or more monolithic server type information handling systems 210. Also, in certain embodiments, the enterprise environment 200 includes one or more modular server type information handling systems 214 which are included within a modular chassis 216. Also, in certain embodiments, the enterprise environment includes a management controller 220, such as a chassis management controller . In certain embodiments, the management controller 220 is also included within the modular chassis 216. In certain embodiments, some or all of the information handling systems 210, 212 include an excess equipment inventory system 130. In certain embodiments, one or more excess equipment inventory systems 130 may be used across an entire enterprise environment 200. The excess equipment inventory systems 130 provide information regarding excess equipment inventory to a master excess equipment record 225 (e.g., a master excess equipment log). The master excess equipment record 225 may be stored within an excess equipment inventory system 130 or may be stored separately from the excess equipment inventory system 130.

In certain embodiments, the management controller 220 is also coupled to one or a plurality of sleds 230 (sled1-sledN). Each sled 230 comprises a chassis as well as a plurality of server type information handling systems. The chassis allows the server type information handling systems to share power supplies and fans across a plurality of server nodes. Also, in certain embodiments, the server type information handling systems within each sled 230 are interchangeable and are networked using top of rack or end of row switches.

Each server type information handling system 210, 212 includes a plurality of devices. Examples of devices include power supply units (PSUs), fans, input/output (I/O) fabric modules, shared storage modules (such as a RAID controller such as a Poweredge RAID Controller (PERC)), control panels (such as LCD type control panels), keyboard, video & mouse (KYM) controllers, active midplanes, smart bezels (e.g., which include near field communication (NEC)), etc. Additional examples of devices include passive midplanes, power distribution modules. etc.

Additionally, each sled 230 includes a plurality of devices. Examples of devices include power supply units (PSUs), fans, input/output (I/O) fabric modules, shared storage modules (such as a RAID controller such as a Poweredge RAID Controller (PERC)), control panels (such as LCD type control panels), keyboard, video & mouse (KVM) controllers, active midplanes, smart bezels (i.e., which include NEC), etc. Additional examples of devices include passive midplanes, power distribution modules, etc.

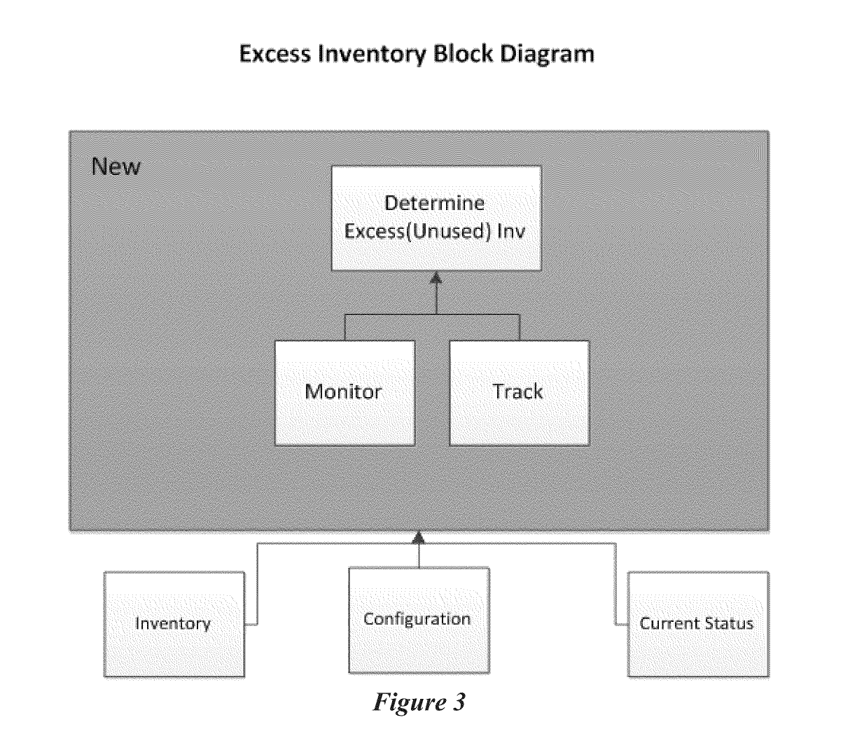

Referring to FIG. 3, a block diagram of an excess equipment inventory system 130 is shown. More specifically, the excess equipment inventory system 130 includes an excess inventory determination module 310 as well as a monitor module 320 and a tracking module 330. The excess equipment inventory system 130 also includes an inventory module 340, a configuration module 350 and a status module 360.

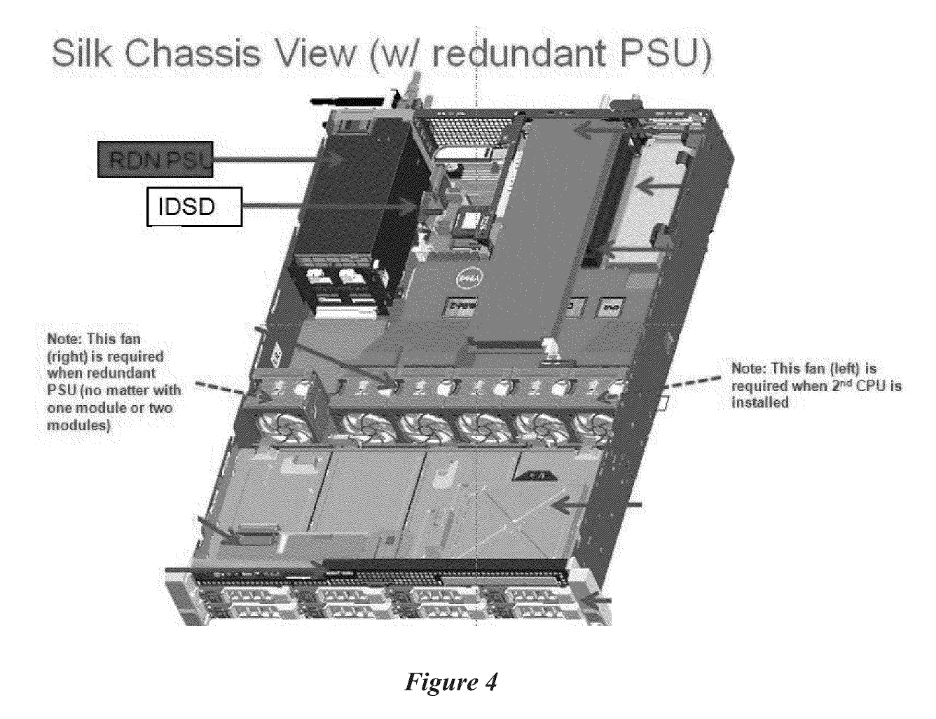

Referring to FIG. 4, an example of a server type information handling system 400 on which the excess equipment inventory system performs an analysis is shown. This example server type information handling system is one example of an information handling system 100 and is also an example of a chassis server which is included within the example enterprise environment 200. The example server type information handling system 400 may be configured with an extra fan 410. This fan 410 is included within to server type information handling system 400 when a redundant power supply 420 is included whether or not a second processor module is included within the server type information handing system 400. Additionally, the extra fan 410 may be required when a second processor module is included within the server type information handling system 400. However, there are certain configurations where the server type information handling system 400 is configured to include the fan 410 even if there is no redundant power supply 420 or second processor module. In this configuration, the extra fan 410 is considered to be excess equipment. Additionally, there are certain configurations where the information handling system 400 is configured with the redundant power supply 420 but this redundant power supply 420 is not used by the information handling system 400. In this configuration, the redundant power supply 420 (and possibly the extra fan 410) is considered to be excess equipment.

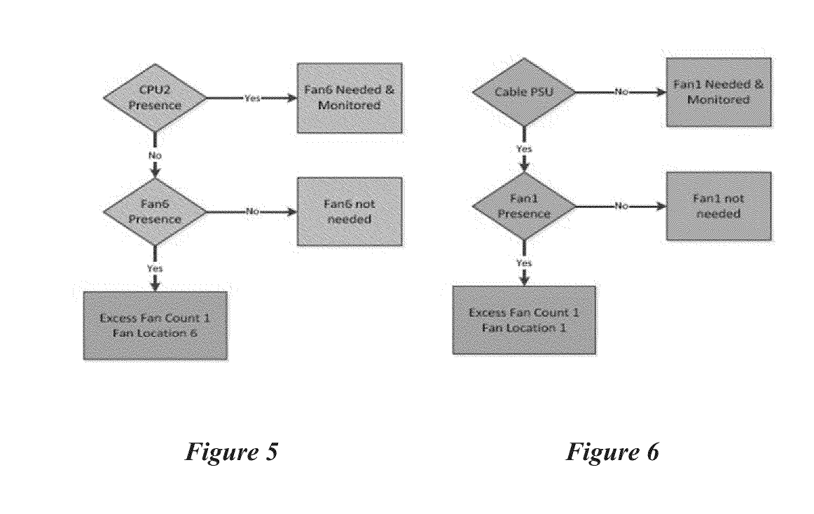

FIG. 5, shows a flow chart of the operation of an excess equipment inventory system when performing an analysis for excess fan equipment. More specifically, the excess equipment inventory operation begins by the management controller determining whether a second processor module is present within a certain information handling system at step 510. If the second processor module is present then the certain information handling system needs the extra fan. Accordingly, the excess equipment inventory system 130 so indicates the need of the extra fan to a master excess equipment inventory log and information handling system is monitored at step 520 for any changes to the presence of the second processor module. If the second processor module is not present as determined by step 510 then the excess equipment inventory system 130 determines whether an extra fan is present within the information handling system at step 530. If an extra fan is not present then the excess equipment inventory system 130 so indicates the lack of the extra fan to the master excess equipment inventory log at step 540. If an extra fan is present, then the excess equipment inventory system 130 increments an extra fan count within the master excess equipment inventory log and identifies the extra fan location at step 550.

FIG. 6, shows a flow chart of the operation of an excess equipment inventory system when performing another analysis for excess fan equipment. More specifically, the excess equipment inventory operation begins by the management controller determining whether a cable is coupled to a redundant power supply within a certain information handling system at step 610. If cable is coupled to redundant power supply then the certain information handling system needs the extra fan. Accordingly, the excess equipment inventory system 130 so indicates the need of the extra fan to a master excess equipment inventory log and information handling system is monitored at step 620 for any changes to the cabling. If the cable is not coupled the redundant power supply as determined by step 610 then the excess equipment inventory system 130 determines whether an extra fan is present within the information handling system at step 630. If an extra fan is not present then the excess equipment inventory system 130 so indicates the lack of the extra fan to the master excess equipment inventory log at step 640. If an extra fan is present, then the excess equipment inventory system 130 increments an extra fan count within the master excess equipment inventory log and identifies the extra fan location at step 650.

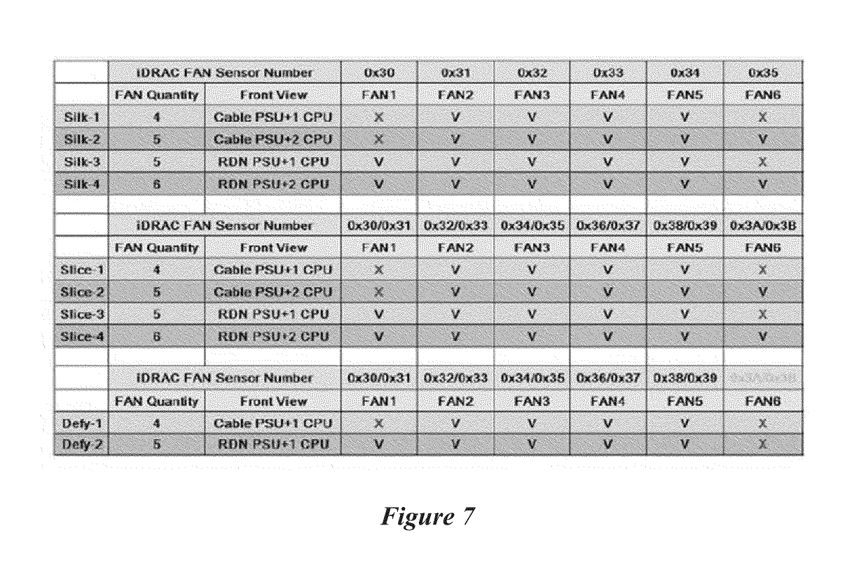

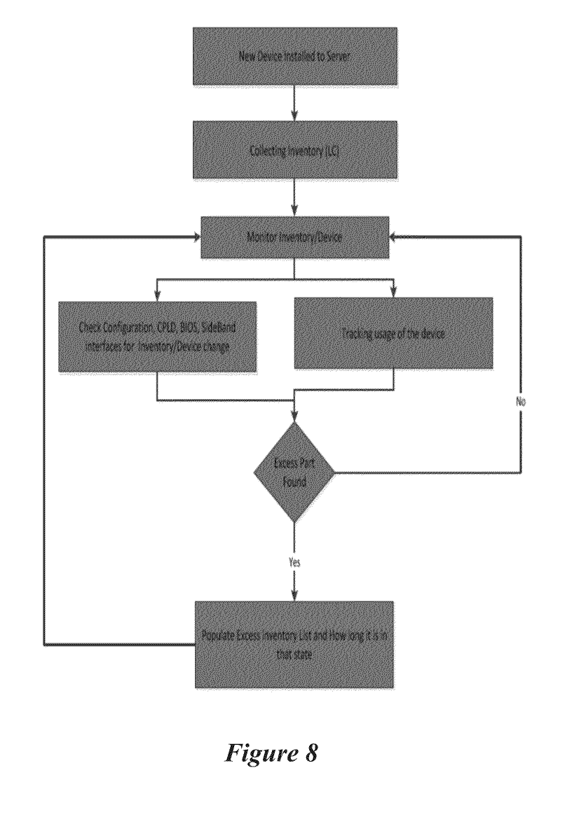

FIG. 7 shows a table representing the various conditions analyzed by the excess equipment inventory system 130 when performing an analysis for excess fan equipment on an example family of server type information handling systems.

More specifically, in one example family of server type information handling systems, different platforms (identified as Silk, Slice and Defy) have different hardware configuration such as CPU1, 2 or Cable PSU/Redundant PSUs which provides information regarding different fan counts as required fans and optional fans. For example, the server type information handling system shown in FIG. 4 explains about the fan needed when CPU2 and a redundant power supply unit. The table shown in FIG. 7 represents an optional fan matrix for an example family of server type information handling systems. In this table an X refers optional fans.

With the system for performing excess equipment inventory operations the information contained within the table is used to determine whether any extra equipment is present for any server type information handling system included within the enterprise environment.

Similar tables may be generated for when an extra power supply unit is present, a second processor module is present as well as when an out of band storage system is disabled. Other configuration options may also be represented by their own respective tables.

Referring to FIG. 8, a flow chart of the operation 800 of an excess equipment inventory system when performing an analysis for excess equipment inventory when a new device is added to the enterprise environment is shown, More specifically, the excess equipment inventory system 130 determines when a new device is installed to an information handling system within the enterprise environment at step 810. The excess equipment inventory system 130 then collects equipment inventory information associated with the information handling system at step 820. Next, at step 830, the excess equipment inventory system 130 monitors the inventory of the information handling system. The excess equipment inventory system 130 continues operation at step 840 by checking the configuration of the information handling system for any changes in the devices within the information handling system and at step 850 by tracking usage of the device. Based upon changes to the configuration of the information handling system or usage of the device within the information handling system, the excess equipment inventory system 130 determines whether any excess devices are present at step 860. If not, then the excess equipment inventory system 130 continues to monitor the information handling system at step 830. If so, then the excess equipment inventory system 130 increments an extra device count within the master excess equipment inventory log and identifies the extra device location at step 670.

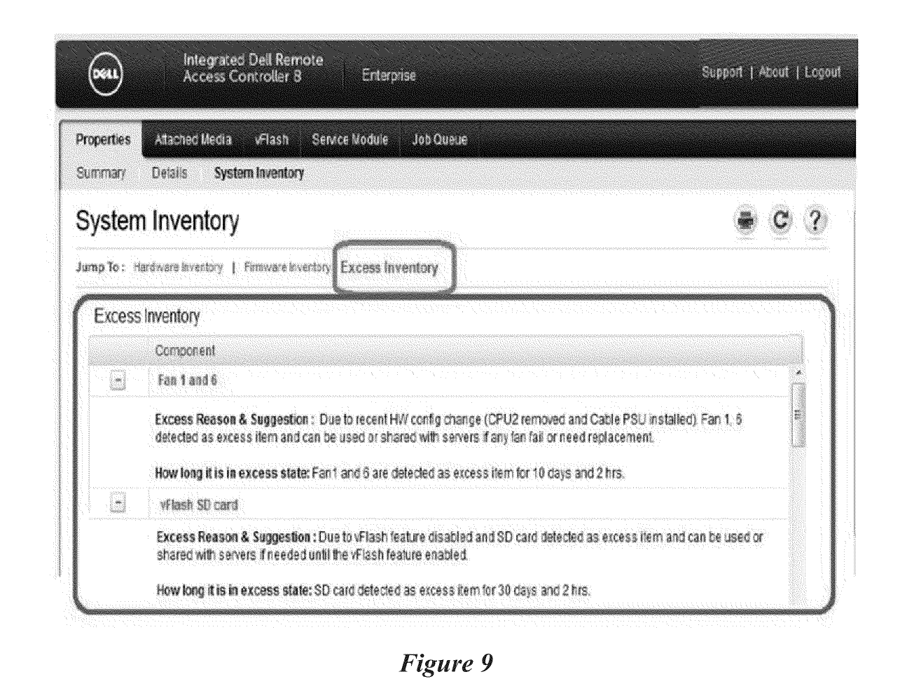

FIG. 9 shows an example screen presentation of an excess equipment inventory report generated by an excess equipment inventory system. More specifically, the excess equipment inventory report screen presentation provides information regarding enterprise wide excess equipment inventory. The excess equipment inventory report screen presentation also provides information regarding suggested actions that a user may take to more fully utilize any excess equipment.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as weft as various input and output (110) devices, such as a keyboard, a mouse, and a video display. The information handling system may also include one or more buses operable to transmit communications between the various hardware components.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server, In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while an example of the operation of the excess equipment inventory system 130 was provided with respect to extra fins, it will be appreciated that such a system could also identify extra SD cards by determining when an out of band shared storage system (e.g. vFlash) is disabled within a particular server type information handling system. More specifically, while many server type information handling systems are purchased with VFlash functionality, which requires SD card presence, certain customers may not use this feature or may disable the configuration (e.g., via a iDRAC user interface). In these cases, SD card contained within the server type information handling system is an excess item. In certain embodiments, the excess equipment inventory system 130 could also be extended to track device usage and to determine whether the SC card is an excess item by tracking SD card reads and/or writes to determine whether the out of band shared storage system is actually being used even if it is enabled. in certain embodiments, this tracking could further determine how long the out of band shared storage system has been unused so that a user might obtain a better understanding of whether the SD card is actually an excess item.

Also for example, it will be appreciated that the excess equipment inventory system could also identify extra power supply units and/or network cards. In certain cases, an information handling system may be configured with a redundant installed power supply unit or a network card which may in fact be excess items. In certain embodiments, the excess equipment inventory system can read power supply logic such as a power supply complex programmable logic device (CPLD) for a power supply unit presence. The system can then determine whether there is input power present to the power supply unit (such as via a power management bus command). If no input power is detected, then the power supply unit can be identified as an excess item. Also, in certain embodiments, the excess equipment inventory system can identify excess network cards. More specifically, the excess equipment inventory system can identify a network port status (such as via a sideband or Network Controller Sideband Interface (NCSI)). The excess equipment inventory system could also detect a network cable presence. The excess equipment inventory could also analyze network traffic for any network packets that are either transmitted or received by the network card. Based upon the results of these operations, the excess equipment inventory system can identify a network card as an excess item.

Also for example, it will be appreciated that the excess equipment inventory system could also identify excess PCI cards. For example, certain information handling systems may be configured to include PCI cards, however, the PCI slots are disabled (e.g., at the BIOS level). In certain embodiments, the excess equipment inventory system scans the PCI cards (such as during a power on self test (POST) process and determines if any of the PCI slots are disabled. If so, then the cards included within these slots can be identified as excess items. Also, for example, it will be appreciated that the excess equipment inventory system could also identify excess hard drives. In certain embodiments, the excess equipment inventory system communicates with a RAM controller such as a power edge RAID controller (PERC) controller to determine disk configuration information (such as RAID configuration). The system could then identify any unused hard drives as excess items.

Also, in certain embodiments, the excess equipment inventory system can track usage information relating to any identified excess item. By tracking usage information even items which may be configured as enabled may be identified as excess items.

Also, in certain embodiments, excess items may also be tracked across a plurality of information handling systems where the excess items are identified by location within the information handling system as well as by a location within the enterprise environment (e.g., such as by using an internet protocol (IP) address or address range).

Consequently, the invention is intended to be limited only by the spirit and scope of the appended claims, giving full cognizance to equivalents in all respects.

What is claimed is:

1. A computer-implementable method for identifying excess equipment inventory within an enterprise environment, comprising:
analyzing components within an information handling system contained in the enterprise environment perform an excess equipment identification, the excess equipment identification determine whether any of the components comprise excess equipment;
storing information regarding whether any of the components are excess equipment within an excess equipment inventory record; and,
informing a user of identified excess equipment via the excess equipment inventory record.

2. The method of claim 1, wherein:
the analyzing is performed by a management controller of the enterprise environment.

3. The method of claim 1, wherein:
the excess equipment inventory identification uses key configuration factors to determine whether a component comprises excess equipment.

4. The method of claim 1, further comprising:
the excess equipment inventory identification uses configuration data to determine whether certain equipment is enabled or disabled.

5. The method of claim 1, wherein
the excess equipment inventory identification tracks usage of a specific component to associate additional usage information with any identified excess equipment.

6. The method of claim 1, wherein:
the excess equipment inventory identification provides usage recommendations regarding whether and where any identified excess equipment may be used within the enterprise environment.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
analyzing components within an information handling system contained in the enterprise environment perform an excess equipment identification, the excess equipment identification determine whether any of the components comprise excess equipment;
storing information regarding whether any of the components are excess equipment within an excess equipment inventory record; and,
informing a user of identified excess equipment via the excess equipment inventory record.

8. The system of claim 7, wherein:
the analyzing is performed by a management controller of the enterprise environment.

9. The system of claim 7, wherein:
the excess equipment inventory identification uses key configuration factors to determine whether a component comprises excess equipment.

10. The system of claim 7, wherein:
the excess equipment inventory identification uses configuration data to determine whether certain equipment is enabled or disabled.

11. The system of claim 7, wherein
the excess equipment inventory identification tracks usage of a specific component to associate additional usage information with any identified excess equipment.

12. The system of claim 7, wherein:
the excess equipment inventory identification provides usage recommendations regarding whether and where any identified excess equipment may be used within the enterprise environment.

13. A non-transitory, computer-readable storage medium embodying computer program code, the computer program code comprising computer executable instructions configured for:
analyzing components within an information handling system contained in the enterprise environment perform an excess equipment identification, the excess equipment identification determine whether any of the components comprise excess equipment;
storing information regarding whether any of the components are excess equipment within an excess equipment inventory record; and,
informing a user of identified excess equipment via the excess equipment inventory record.

14. The non-transitory, computer-readable storage medium of claim 13, wherein:
the analyzing is performed by a management controller of the enterprise environment.

15. The non-transitory, computer-readable storage medium of claim 13, wherein:
the excess equipment inventory identification uses key configuration factors to determine whether a component comprises excess equipment.

16. The non-transitory, computer-readable storage medium of claim 13, wherein:
the excess equipment inventory identification uses configuration data to determine whether certain equipment is enabled or disabled.

17. The non-transitory, computer-readable storage medium of claim 13, wherein the excess equipment inventory identification tracks usage of a specific component to associate additional usage information with any identified excess equipment.

18. The non-transitory, computer-readable storage medium of claim 13, wherein:
the excess equipment inventory identification provides usage recommendations regarding whether and where any identified excess equipment may be used within the enterprise environment.
